(19) United States
(12) Patent Application Publication
(10) Pub. No.: US 2019/0394583 A1
(43) Pub. Date: Dec. 26, 2019

(54) METHOD OF AUDIO REPRODUCTION IN A HEARING DEVICE AND HEARING DEVICE

(71) Applicant: SIVANTOS PTE. LTD., SINGAPORE (SG)

(72) Inventors: BOON SIANG TAN, SINGAPORE (SG); HOONG YIH CHAN, SINGAPORE (SG); HENNING PUDER, ERLANGEN (DE); TOBIAS DANIEL ROSENKRANZ, ERLANGEN (DE)

(21) Appl. No.: 16/447,224

(22) Filed: Jun. 20, 2019

(30) Foreign Application Priority Data
Jun. 20, 2018 (DE) 102018210053.5

(51) Int. Cl. H04R 25/00; H04S 7/00; H04S 3/00

(52) U.S. Cl. CPC H04R 25/552; H04R 25/558; H04S 7/304; H04R 2225/55; H04S 3/008; H04S 2400/01; H04S 2420/01; H04S 3/004

(57) ABSTRACT

In a method of audio reproduction in a hearing device, a first external signal is provided, a geometric data set is predetermined for a head shape of a user of the hearing device, and a first position is predetermined for a first virtual speaker. A propagation of the first external signal from the first virtual speaker to a first local unit of the hearing device is simulated based on the geometric data set for the head shape of the user and on the first position and a first virtual spatial signal is generated in the process. A first reproduction signal is generated from the first virtual spatial signal, and a first output transducer reproduces the first reproduction signal in the first local unit of the hearing device.

### CROSS-REFERENCE TO RELATED APPLICATION

This application claims the priority, under 35 U.S.C. § 119, of German application DE 10 2018 210 053.5, filed Jun. 20, 2018; the prior application is herewith incorporated by reference in its entirety.

### BACKGROUND OF THE INVENTION

### Field of the Invention

The invention relates to a method of audio reproduction in a hearing device, wherein a first external signal is provided, a first reproduction signal is generated from the first external signal, and wherein the first reproduction signal is reproduced by a first output transducer in the first local unit of the hearing device.

As a result of continuously-improving functionality, a hearing device is able to deliver satisfactory, realistic sound to a user in more and more situations. One exception to this, currently, is the integration of hearing devices into higher-level acoustic consumer electronics, such as those found in surround-sound systems and/or home theater stems. The mere transmission of external audio signals, as used in consumer electronics, to the hearing device, and also the reproduction of such external audio signals in the presence of additional, relevant background noise for hearing devices, are already dealt with in a variety of ways, but there is still a lot of additional work needed in this regard, especially in relation to reproducing external audio signals that are intended for a channel surround-sound system.

Currently, stereo signals are usually transmitted from a consumer electronics system such as a television set to a hearing device. Even if the audio tracks are available in multi-channel surround quality, this multi-channel audio track is mixed down to a two-channel stereo signal (i.e. a left and a right channel) by streaming it to the hearing device before transmission. As a result, acoustic information is lost that is valuable for a realistic sound and the corresponding intended experience of a full spatial perception, because a full spatial sound image may no longer be easily produced from two channels alone (and in particular, it cannot be produced without making additional assumptions during the corresponding preprocessing).

The usual streaming protocols do not currently envision the complete transmission of the multi-channel audio track in surround quality to the hearing device. Using the multi-channel audio track would also not serve the purpose in this case. If, for example, the user of the hearing device is exposed to the full surround sound produced by the real surround-sound system using the hearing device's electroacoustic functionality, the user will receive the individual sound signals from the surround channels in a way that is realistic for the user. Shadowing effects, in particular those from the user's head, also play a role in this. All this would be lost if the multi-channel audio track were used, so an improved sound perception would not necessarily be expected.

### SUMMARY OF THE INVENTION

Accordingly, the object of the invention is to set forth a method for audio reproduction of external signals in a hearing device that provides the user with the most realistic possible spatial hearing experience.

This problem is solved according to the invention by a method of audio reproduction in a hearing device as invented. A first external signal is provided. A geometric data set is predetermined for a head shape of a hearing device user. A first position is predetermined for a first virtual speaker. A propagation of the first external signal from the first virtual speaker to a first local unit of the hearing device is simulated based on the first position and the geometric data set for the head shape of the user and a first virtual spatial signal is generated in the process. A first reproduction signal is generated based on the first virtual spatial signal, and the first reproduction signal is reproduced by a first output transducer in the first local unit of the hearing device. Configurations that are advantageous and in part inventive in their own right are the subject matter of the dependent claims and the following description.

An “external signal” refers in particular to a signal the acoustic information of which is not generated inside the hearing device, for example by an input transducer of the hearing device, but has already been completely encoded when the hearing device first picks up the external signal. In particular, an external signal is an electromagnetic signal provided to the hearing device via a suitable wireless data processing or signal processing protocol. Thus, the acoustic information of the external signal is already encoded in the electromagnetic signal before it reaches the hearing device. Here and hereinafter, a notable example of an external signal is a streaming signal in particular. Providing an external signal encompasses in particular the step of an external unit transmitting the data or signal of the external signal to the hearing device.

A “geometric data set” for a head shape of the user of the hearing device, in particular, encompasses a data set that, for a volume element in a detected region, permits an association either with the head of the user or with the environment of the head, and/or permits a demarcation of the head surface from its environment. The geometric data set for the user's head shape preferably resolves in particular the shape of the user's face and preferably also the shape of both of the user's pinnae.

Here and hereinafter, generating a virtual spatial signal encompasses in particular that a signal is simulated and/or generated which, from a structural standpoint, has as far as possible the same properties and acoustic information as a real sound signal that propagates from a real speaker at the corresponding position of the virtual speaker relative to the relevant—in this case, the first—local unit of the hearing device. A given external signal—here, the first external signal—is used as the real sound signal. In this sense, a first position for the first virtual speaker is provided that preferably corresponds to a position of a real speaker of an audio reproduction device, which is used in particular to provide the first external signal to the hearing device. While this real speaker of the audio reproduction device preferably reproduces the first external signal, the sound signal that results from this reproduction and its propagation to the first local unit of the hearing device, including the shadowing effects caused by the user's head, are now simulated based on the geometric data set for the user's head shape, by having the first external signal from the first virtual speaker propagated via the geometric data set to the first local unit of the hearing device, taking into account the head shape. The signal that results from this simulation forms the first virtual spatial signal.

The first virtual spatial signal generated in this way is used to generate a first reproduction signal, which a first output transducer of the first local unit reproduces. Here and hereinafter, an “output transducer” in particular encompasses such a transducer that is adapted to convert an electrical signal into a sound signal, and in particular to an electroacoustic transducer such as a speaker, or to a bone conduction receiver. When the first output transducer reproduces the first reproduction signal, the corresponding sound signal is generated. The generation of the first reproduction signal based on the first virtual spatial signal may in particular take place in such a way that the first virtual spatial signal is incorporated in the first reproduction signal in a linear manner on at least a frequency-band-specific basis; in other words, the first reproduction signal is formed at least on a frequency-band basis by the first virtual spatial signal or by a superposition of the first virtual spatial signal with additional signals.

The described method of audio reproduction in a hearing device may advantageously be carried out in the presence of an audio reproduction unit that reproduces at least the first external signal through a number of real speakers and simultaneously provides this signal to the hearing device. In particular, in this case, the first position is determined by a position of a real speaker of the audio reproduction unit.

A spatial sound sensation of the sound signal that the audio reproduction unit generates may be simulated by taking into account the user's head shape in a simulation of the propagation of the first external signal to the first local unit from a first virtual speaker positioned in particular at the location of a real speaker of the audio reproduction unit. However, the use of the first external signal that is provided directly to the hearing device, instead of an actually-propagating sound signal from the audio reproduction unit, has the advantage that there is no need to reduce additional background noise and that the sensitivity of the input transducer(s) of the hearing device may be reduced to such an extent that, for example, acoustic feedback and/or other background noise is completely suppressed.

Preferably, a first head-related transfer function is determined for the head shape of the user based on the geometric data set and in particular based on the first position, and the propagation of the first external signal, from the first virtual speaker to the first local unit of the hearing device for generating the first virtual spatial signal, is simulated using the first head-related transfer function. In this case, the first head-related transfer function (HRTF) is the relevant transfer function for propagating a sound signal from the first position to the first local unit, which in particular also takes into account possible shadowing effects from the user's head during propagation, and is individually adapted to the specific anatomy of the user's head.

Notably, this HRTF forms an individual characteristic pattern of resonances with distinct spectral maxima and sharply defined spectral minima, the frequency response of which respectively varies as a function of the direction of a sound source. The resonances in this case are formed in resonant spaces in the ear, the spectrally most important resonance spaces being the concha, fossa and scapha. The frequencies for the spectral minima and maxima as well as the respectively associated frequency response may be ascertained using statistical regression models based on measurement data of the ear, which in particular provide information about these resonance spaces. For the statistical regression models, geometric data sets for the ears of a plurality of persons should preferably be created, and the direction- or angle-resolved HRTFs of the persons should be measured. For the individual spectral minima and maxima, respectively direction-dependent curves may now be ascertained via regressions in which geometric shape parameters of the ear occur as coefficients and by which the respective spectral minimum or maximum is interpolated for any given geometric shape parameters. A final HRTF may now be formed based on the spectral minima and maxima.

Expediently, the geometric data set for the user's head shape is generated by a mobile telephone using a number of image recordings, and is transmitted to the hearing device for presetting. In this case, in particular, a given standard protocol for facial recognition may be used, such as is used for example to increase security in mobile telephones. Alternatively, the geometric data set for the head shape of the user may also be generated by an independent application on the mobile telephone that is specially furnished and set up for this purpose and gives the user of the hearing device instructions for using the camera of the mobile telephone to take a number, in particular a plurality, of image recordings of the user's head and in particular of the user's face. In particular, such a stand-alone application may access the data of a standard facial recognition protocol as part of the security measures of the mobile telephone in order to edit and/or “render” a corresponding geometric data set generated therein for use in the hearing device; in this way, the data of the standard facial recognition protocol are compatible for use in the hearing device.

In particular, if a first HRTF is determined based on the geometric data set, and a propagation of the first external signal from the first virtual speaker to the first local unit of the hearing device for generating the first virtual spatial signal is simulated based thereon, the spectrally important resonance spaces in the user's ear that are characteristic of the HRTF may be detected based on these image recordings. In particular, a mobile telephone may thus generate at least one image recording by which an ear of the user may first be measured in detail, with the measurement data preferably providing information about these resonance spaces. Preferably, additional information relevant for the propagation of sound in the immediate vicinity of the head, e.g. with regard to the head shape and the curvature of the cheeks, forehead and chin, may be extracted by means of an image recording generated by the mobile telephone.

Based on the geometric information regarding these resonance spaces, the direction- and/or angle-resolved HRTF for the associated ear may then be determined using statistical regression models, for example based on geometric data sets of a plurality of persons. A completely independent, frequency- and/or angle-based numerical simulation of sound propagation is also possible that takes into account the ear geometry that has been measured based on the image recordings, and in particular the resonance spaces. Such a selection using a statistical regression model, or a numerical simulation of sound propagation, is possible either on the mobile telephone itself, using a corresponding application that in the case of the regression model optionally is adapted to obtain additional data from a corresponding server-based database concerning the geometric data sets and HRTFs of the persons on whom the statistical regression model is based.

The plurality of image recordings may also be transmitted to a central database server or a central computer, for example via an appropriate Internet transmission protocol. The relevant curves for the user's HRTF may then be ascertained based on the or each image recording on this database server, on which the corresponding geometrical and HRFT data of other persons are stored for the statistical regression model, or numerically simulated on a central computer having suitable computational performance.

Favorably, a second external signal is provided, a second position is predetermined for a second virtual speaker, a propagation of the second external signal from the second virtual speaker to the first local unit of the hearing device is simulated based on the geometric data set for the head shape of the user and on the second position, and a second virtual spatial signal is generated in the process, and the first reproduction signal is generated from the second virtual spatial signal. Preferably, the first reproduction signal is generated by a superposition, optionally weighted, of the first virtual spatial signal and the second virtual spatial signal and possibly additional signals. In particular, the description of the first external signal, first virtual speaker or first virtual spatial signal applies analogously to the second external signal, second virtual speaker and second virtual spatial signal.

The integration of a second external signal and a second virtual speaker allows in particular applying the invention to external signals that an audio reproduction unit with at least two speakers provides, e.g. stereo systems the speakers of which are positioned at a distance from each other in space, or surround-sound systems that provide only a two-channel stereo signal as the first and second external signal. In particular, the second position is determined by the position of one of the real speakers of the audio reproduction unit.

It also proves advantageous in that case if a third external signal is provided, a third position for a third virtual speaker is predetermined, a propagation of the third external signal from the third virtual speaker to the first local unit of the hearing device is simulated based on the geometric data set for the head shape of the user and on the third position, and a third virtual spatial signal is generated in the process, and the first reproduction signal is generated from the third virtual spatial signal. Preferably, the first reproduction signal is generated by a possibly weighted superposition of the first virtual spatial signal with the second virtual spatial signal and the third virtual spatial signal, and optionally with additional signals. In particular, the description of the first external signal, first virtual speaker or first virtual spatial signal applies analogously to the third external signal, third virtual speaker and third virtual spatial signal.

By extending the procedure to a third external signal and in particular to additional external signals and corresponding virtual speakers with their associated positions, the method may also be used with audio reproduction units that have more than two speakers, such as “true” surround-sound systems in which the sound image achieved may be reproduced particularly realistically. Each external signal that a separate speaker of the audio reproduction unit reproduces is taken into account in the method, and its propagation is used to generate a corresponding virtual spatial signal that also takes into account the shadowing effects due to the head of the user of the hearing device, in particular via the HRTF. The external signals may be provided directly by the audio reproduction unit, for example by the external signals being sent to the speakers via Bluetooth or another streaming protocol and being received by the hearing device. The audio reproduction unit may also generate its own transmission signal for hearing devices, in which the external signals intended for the speakers are mixed together (“downmixing”). In this case, in particular, the individual tracks from this transmission signal may be restored as external signals using special “upmix” protocols.

In an advantageous configuration of the invention, a propagation of the first external signal from the first virtual speaker to a second local unit of the hearing device is simulated based on the geometric data set for the user's head shape and on the first position and an additional virtual spatial signal is generated in the process, a second reproduction signal is generated based on the additional virtual spatial signal and in particular also based on an additional virtual spatial signal generated by a second external signal, and a second output transducer reproduces the second reproduction signal in the second local unit of the hearing device.

In particular, the same applies for the second reproduction signal as described analogously for the first reproduction signal. The method describes herein allows integrating binaural hearing devices that comprise two local units into the method, which is particularly advantageous for spatial sound perception.

Preferably, two virtual spatial signals are generated for each external signal, with one of the two virtual spatial signals corresponding to the propagation of the relevant external signal from the associated virtual speaker to the first local unit, and the other virtual spatial signal corresponding to the propagation of the relevant external signal from the associated virtual speaker to the second local unit. Preferably, the first reproduction signal is then generated using those virtual spatial signals that correspond to propagation to the first local unit, and the second reproduction signal is generated using those virtual spatial signals that correspond to propagation to the second local unit.

It is also advantageous if a head movement by the hearing device user is recorded to preset the first position and in particular all other relevant positions. The detection may be done for example by a motion and/or acceleration sensor in the hearing device, particularly in the first local unit of the hearing device. Preferably, a starting position is preset as a reference for the first position, and the first position is updated using the detected head movements with respect to this reference. In particular, in this case, preset starting positions may correspond to the real speaker positions of the audio reproduction unit that provides the external signals.

The output position may be preset manually or, for example, by means of a calibration procedure, in particular using the input transducers of the hearing device, by evaluating the individual sound signals that the speakers of the audio reproduction unit generate. In this context, the advantage of presetting the first position based on the user's head movement is that the sound adapts to the user's head movement, and for example when turning to the right, the change in shadowing effects occurring in real sound signals may be taken into account by changing the positions of the virtual speakers. The result is a sound image in which the sound the user hears corresponds exactly to the user's body movements.

In particular, it has proven advantageous if propagation of the first external signal from the first virtual speaker to the first local unit of the hearing device is simulated using an HRTF, thus generating the first virtual spatial signal. An HRTF allows frequency- and angle-dependent information about the propagation of a sound signal, in particular in the immediate vicinity of the ear, and about the influence of the individual resonance spaces at the ear on propagation.

Expediently, a first channel of a multi-channel surround signal is provided as the first external signal. In particular, the other channels of the surround signal are provided as additional external signals. The application of this method is particularly advantageous for improving the spatial sound perception of streamed surround signals.

Preferably, the first channel of the multi-channel surround signal is provided by direct transmission to the hearing device. This is particularly advantageous if the signals to be played back by the respective speakers are transmitted wirelessly in the surround-sound system, e.g. via Bluetooth or similar streaming protocols. In this case the external signals do not have to be generated additionally to integrate the hearing device, but may simply be tapped as the corresponding channels of the streaming signal.

Alternatively, a stereo signal or mono signal is transmitted to the hearing device, and the first channel of the multi-channel surround signal is provided from the stereo signal or mono signal by preprocessing in the hearing device. This is particularly advantageous if transmitting the individual channels of the surround-sound system as external signals is not provided for, or is technically impossible. In this case, the external signals may be obtained from the stereo signal by preprocessing, which may consist of an upmix in particular.

The invention also mentions a hearing device with at least one local unit, which is set up to carry out the above-described method. In particular, the local unit is adapted to receive a number of external signals and decode the acoustic information contained therein, to generate a virtual spatial signal for each of the external signals based on a corresponding number of positions, and to generate and reproduce a reproduction signal from the virtual spatial signals. The advantages mentioned for the provided method and for the refinements thereof may be transferred analogously to the hearing device.

Other features which are considered as characteristic for the invention are set forth in the appended claims.

Although the invention is illustrated and described herein as embodied in a method of audio reproduction in a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a top view of a hearing device with two local units, which its user uses in a surround-sound system;

FIG. 2 is a block diagram of a method for generating two reproduction signals for the hearing device 4 according to FIG. 1; and

FIG. 3 is a schematic cross-section through a geometric data set for a head shape of the user of the hearing device according to FIG. 1.

### DETAILED DESCRIPTION OF THE INVENTION

Components and magnitudes that correspond to each other are respectively assigned the same reference signs in all drawings.

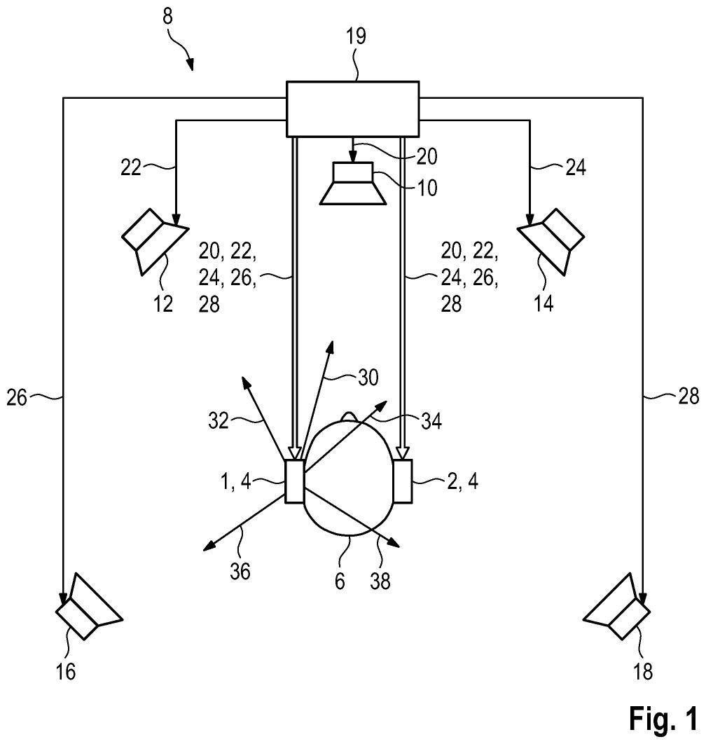

Referring now to the figures of the drawings in detail and first, particularly to FIG. 1 thereof, there is shown a schematic top view of a first local unit 1 and second local unit 2 of a hearing device 4. A user 6 of the hearing device 4 must wear the first local unit 1 and second local unit 2 on the left and right ear respectively. The user 6 who wears the hearing device 4 is now surrounded by a surround-sound system 8 containing a front speaker 10, a front left speaker 12, a front right speaker 14, rear left speaker 16 and rear right speaker 18. For better spatial sound, the individual speakers 10 to 18 reproduce different input signals provided by a central unit 19 arranged directly on the front speaker 10. Thus, the front speaker 10 receives a front output signal 20 from the central unit 19, the front left speaker 12 receives a front left output signal 22 from the central unit 19, the front right speaker 14 receives a front right output signal 24, the rear left speaker 16 receives a rear left output signal 26, and the rear right speaker 18 receives a rear right output signal 28.

In this case, the output signals 20 to 28 are transmitted respectively as external signals to the first local unit 1 and to the second local unit 2 of the hearing device 4, via a corresponding streaming protocol. The central unit 19 transmits the data, but if the speakers 10 to 18 are set up appropriately, the data may also be transmitted via the speakers 10 to 18 themselves, each respectively transmitting their own output signal 20 to 28 to the first local unit 1 and second local unit 2.

The frontal output signal 20 thus enters the first local unit 1 as a first external signal, the front left output signal 22 enters as a second external output signal, the front right output signal 24 enters as a third external signal, and so on. In the second local unit, these output signals 20 to 28 likewise enter as a first or second or third external signal.

The external signals 20 to 28 are now each respectively processed in the two local units 1, 2 in such a way that a realistic spatial hearing sensation is created for the user 6, as would be the case with hearing real sounds in the surround-sound system 8.

This is illustrated schematically for the first local unit 1, by way of example. The hearing device 4 is given information about the positions of the speakers 10 to 18. This may be done by directly transmitting position information from the respective speaker 10 to 18 to the respective local unit 1, 2, or by a corresponding user input. The first local unit 1 now contains a first position 30, a second position 32, a third position 34, a fourth position 36 and a fifth position 38 of the front speaker 10, the front left speaker 12, the front right speaker 14, the rear left speaker 16 and the rear right speaker 18. For each of the positions 30 to 38, the first local unit 1 also provides a respective head-related transfer function for propagating a sound signal from the corresponding speaker 10 to 18 to the first local unit 1. The corresponding head-related transfer function is now used to calculate how a sound signal that a speaker positioned at the first position 30 would generate via the first external signal 20 (which corresponds to the frontal output signal 20), is propagated to the first local unit 1, and is thereby in particular shadowed by the head of the user 6. A virtual spatial signal, which has not yet been described, is thus generated and is used to generate a reproduction signal for the first local unit 1. This reproduction signal of the first local unit 1 also includes the virtual spatial signals that correspond to the other output signals 22 to 28 or the remaining speakers 12 to 18.

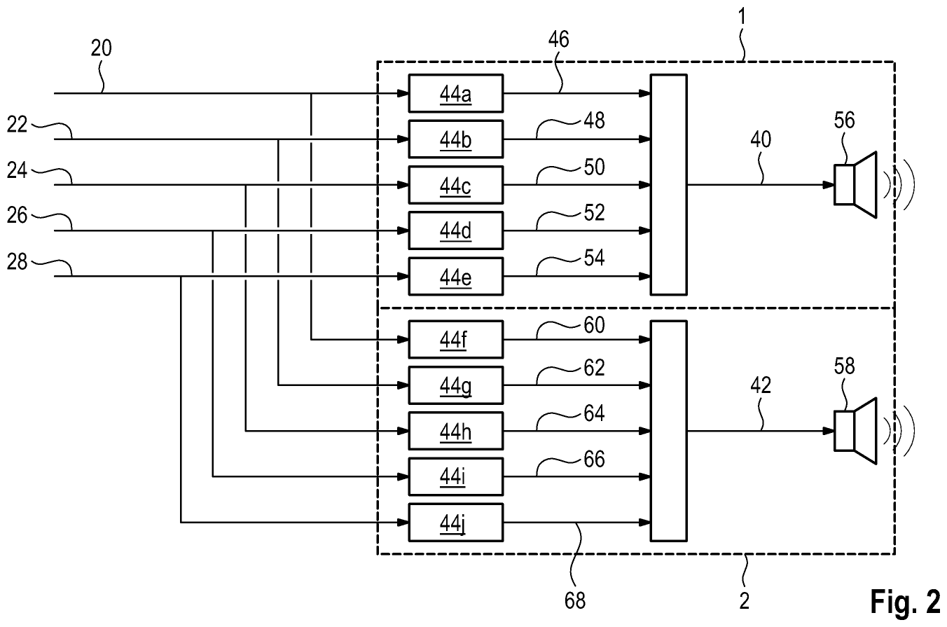

FIG. 2 shows a schematic block diagram of a method for generating a first reproduction signal 40 and second reproduction signal 42 for the hearing device 4 according to FIG. 1. The output signals 20 to 28, which are transmitted as external signals to the first local unit 1 and the second local unit 2, are first respectively filtered with an HRTF 44. The HRTF 44a corresponds to the propagation to the first local unit 1 of a sound signal that a virtual speaker that corresponds to the frontal speaker 10 generated at the first position 30. A comparable situation applies to the other HRTFs 44b to j with regard to the propagation of a sound signal from the second to fifth position 32 to 38 to the first local unit 1 or from the first to fifth position 30 to 38 to the second local unit 2.

The first external signal corresponding to the frontal output signal 20 is now filtered with the HRTF 44a, generating a first virtual spatial signal 46. Accordingly, the second external signal corresponding to the front left output signal 22 is filtered with the HRTF 44b, generating a second virtual spatial signal 48. Comparably, a third virtual spatial signal 50 is generated from the third external signal, corresponding to the front right output signal 24, and so on. The five virtual spatial signals 46 to 54 are now combined, optionally with a corresponding weighting, to form the first reproduction signal 40. A first output transducer 56 reproduces the first reproduction signal 40 for the user 6 in the first local unit 1 of the hearing device 4.

Similarly, a second output transducer 58 generates and reproduces the second reproduction signal to the user 6 in the second local unit 2 of the hearing device 4. When generating the second reproduction signal 42, the first external signal corresponding to the frontal output signal 20 in particular is filtered with the HRTF 44f, which corresponds to a sound signal propagating to the second local unit 2 from a virtual speaker positioned at the first position 30. In particular, an additional virtual spatial signal 60 is generated that is used together with the other virtual spatial signals 62 to 68 to form the second reproduction signal 42.

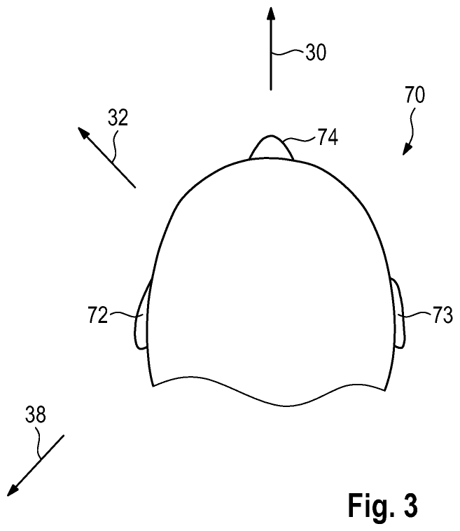

FIG. 3 schematically shows a cross-section through a geometric data set 70 for a head shape of the user 6 of the hearing device 4 according to FIG. 1. The sectional plane cuts transversely at the height of the ears 72, 73 and nose 74 of the user 6. Plainly, due to symmetry, a sound signal generated by a speaker arranged at the first position 30 may propagate almost in the same way to the left ear 72 as to the right ear 73. For this reason, in FIG. 2 the virtual spatial signals 46, 60 that the corresponding HRTF generates do not differ significantly with respect to the first position 30. This is no longer the case, however, for a sound signal that a speaker arranged at the second position 32 generates, due to the shadowing by the nose 74, which already occurs during propagation to the right ear 73. Accordingly, the corresponding virtual spatial signals that enter into the first or second reproduction signal 40 or 42 are different. A sound signal that a speaker arranged at the fourth position 36 generates is also shadowed by the auricle during propagation to the left ear 72. The shadowing effects of the ears 72, 73 and the nose depend to a considerable extent on the anatomical properties of the user 6. This is all the more the case if the head movements of the user 6 relative to the physical speakers 10 to 18 of the surround-sound system 8 are also recorded in presetting the position of the virtual speakers for which the virtual spatial signals according to FIG. 2 are to be generated.

Although the invention has been illustrated and described in greater detail with reference to the preferred exemplary embodiment, this exemplary embodiment does not limit the invention. A person of ordinary skill in the art will be able to derive other variations from this exemplary embodiment, without departing from the invention's protected scope.

The following is a summary list of reference numerals and the corresponding structure used in the above description of the invention:
1 First local unit
2 Second local unit
4 Hearing device
6 User
8 Surround-sound system
Front speaker
12 Front left speaker
14 Front right speaker
16 Rear left speaker
18 Rear right speaker
19 Central unit
20 Front output signal, first external signal
22 Front left output signal, second external signal
24 Front right output signal, third external signal
26 Rear left output signal
28 Rear right output signal
30 First position
32 Second position
34 Third position
36 Fourth position
38 Fifth position
40 First reproduction signal
42 Second reproduction signal
44a-j HRTF (head-related transfer function)
46 First virtual spatial signal
48 Second virtual spatial signal
50 Third virtual spatial signal
52 Fourth virtual spatial signal
54 Fifth virtual spatial signal
56 First output transducer
58 Second output transducer
60 Additional virtual spatial signal
62-68 Other virtual spatial signals
70 Geometric data set
72 Ear (left)
73 Ear (right)
74 Nose

1. A method of audio reproduction in a hearing device, which comprises the steps of:
providing a first external signal;
predetermining a geometric data set for a head shape of a user of the hearing device;
predetermining a first position for a first virtual speaker;
simulating a propagation of the first external signal from the first virtual speaker to a first local unit of the hearing device based on the geometric data set for the head shape of the user and on the first position, and a first virtual spatial signal is generated in the process;
generating a first reproduction signal from the first virtual spatial signal; and
reproducing, via a first output transducer, the first reproduction signal in the first local unit of the hearing device.

2. The method according to claim 1, which further comprises:
determining a first head-related transfer function for the head shape of the user based on the geometric data set and based on the first position; and
simulating a propagation of the first external signal, from the first virtual speaker to the first local unit of the hearing device for generating the first virtual spatial signal, using the first head-related transfer function.

3. The method according to claim 1, which further comprises:
generating the geometric data set for the head shape of the user by a mobile telephone by means of a number of image recordings; and
transmitting the geometric data set to the hearing device as a preset.

4. The method according to claim 1, which further comprises:
providing a second external signal;
predetermining a second position for a second virtual speaker,
simulating a propagation of the second external signal from the second virtual speaker to the first local unit of the hearing device based on the geometric data set for the head shape of the user and on the second position, and a second virtual spatial signal is generated in the process; and
generating the first reproduction signal from the second virtual spatial signal.

5. The method according to claim 4, which further comprises:
providing a third external signal;
predetermining a third position for a third virtual speaker;
simulating a propagation of the third external signal from the third virtual speaker to the first local unit of the hearing device based on the geometric data set for the head shape of the user and on the third position, and a third virtual spatial signal is generated in the process; and
generating the first reproduction signal from the third virtual spatial signal.

6. The method according to claim 1, which further comprises:
simulating a propagation of the first external signal from the first virtual speaker to a second local unit of the hearing device based on the geometric data set for the head shape of the user and on the first position, and an additional virtual spatial signal is generated in the process;
generating a second reproduction signal based on the additional virtual spatial signal; and
reproducing, via a second output transducer, the second reproduction signal in the second local unit of the hearing device.

7. The method according to claim 1, which further comprises detecting a head movement of the user of the hearing device in order to preset the first position.

8. The method according to claim 1, which further comprises providing a first channel of a multi-channel surround signal as the first external signal.

9. The method according to claim 8, which further comprises providing the first channel of the multi-channel surround signal by direct transmission to the hearing device.

10. The method according to claim 8, which further comprises:
transmitting a stereo signal or a mono signal to the hearing device; and
providing the first channel of the multi-channel surround signal from the stereo signal or the mono signal, respectively, by preprocessing in the hearing device.

11. A hearing device, comprising:
at least one local unit for audio reproduction, said at least one local unit programmed to:
provide a first external signal;
predetermine a geometric data set for a head shape of a user of the hearing device;
predetermine a first position for a first virtual speaker;
simulate a propagation of the first external signal from the first virtual speaker to said local unit of the hearing device based on the geometric data set for the head shape of the user and on the first position, and a first virtual spatial signal is generated in the process;
generate a first reproduction signal from the first virtual spatial signal; and
reproduce, via a first output transducer, the first reproduction signal in the first local unit of the hearing device.
